(19) United States
(12) Patent Application Publication
(10) Pub. No.: US 2004/0208335 A1
(43) Pub. Date: Oct. 21, 2004

(54) Headphones

(76) Inventor: Achim Gleissner, Barienrode (DE)

Correspondence Address: Gerald H. Kiel, Esq., REED SMITH LLP, 599 Lexington Avenue, New York, NY, 10022-7650, US

(21) Appl. No.: 10/626,129

(22) Filed: Jul. 24, 2003

(30) Foreign Application Priority Data
Jul. 24, 2002 (DE) 102 33 444.7

(51) Int. Cl. H04R 25/00

(52) U.S. Cl. 381/370; 381/384

(57) ABSTRACT

Headphones, and also wireless and wire-bound headphones, have been known for a long time. The disadvantage of wire-bound headphones is that the user cannot move or can move very little when he is using these headphones. The disadvantage of wireless headphones is often the fact that they usually take up a large volume and are heavy and, furthermore, cannot be used for many applications. The object of the present invention is to remove these above-mentioned disadvantages. The receive section of headphones of the “wireless type” for receiving sound signal data transmitted in wireless manner, characterized in that the receive section can be detachably connected to the wireless headphones by a plug-in connection, the plug-in connection preferably being designed so that a plug of commercially available, wire-bound headphones can be inserted into the plug part of the receive section.

### CROSS-REFERENCE TO RELATED APPLICATION

This application claims priority of German Application No. 102 33 444.7, filed Jul. 24, 2002 the complete disclosure of which is hereby incorporated by reference.

### BACKGROUND OF THE INVENTION

a) Field of the Invention

Headphones, both wireless and wire-bound headphones, have been known for a long time.

b) Disadvantages of Known Devices

The disadvantage of wire-bound headphones is that the user cannot move or can move very little when he is using these headphones. The disadvantage of wireless headphones is often the fact that they usually take up a large volume and are heavy and, furthermore, cannot be used for many applications.

### OBJECT AND SUMMARY OF THE INVENTION

The primary object of the present invention is to remove the above-mentioned disadvantages.

The object is achieved with wireless headphones for receiving sound signal data transmitted in wireless manner, the receive section comprising a bush which is configured to house a plug of the headphones with previous wireless headphones, the entire receive are accommodated in the headphones housing and cannot be separated from them. The receive electronics is securely connected to the acoustic transducers of the wireless headphones so that known wireless headphones have hitherto only been able to be used for specific applications.

It is now proposed in accordance with the invention that at least the receive electronics of the wireless headphones are accommodated in a housing and is connected to the remaining part of the headphones via a plug-in connection.

In this case, the plug-in connection is preferably designed so that it fits with a plug of commercially available headphones.

With the solution according to the invention, the wireless headphones comprise a detachable module via a replaced plug-in connection, in which the receive electronics, the amplifier and also the energy storage (batteries) are preferably accommodated. Thus, it is possible to connect the module to wireless headphones with a corresponding plug-in connection and also with commercially available wire-bound headphones and to operate it.

The receiver in the receive module may be an infrared receiver, an HF receiver or a radio receiver (VHF, DAB, etc.) and with an appropriate adjusting direction (rotary knobs, keys, etc.), it is possible to adjust the reproduction, loudness or reception accordingly.

The invention is explained in further detail below with reference to an exemplified embodiment represented in the drawings.

### BRIEF DESCRIPTION OF THE DRAWINGS

In the drawings:

FIG. 1 shows a representation of wireless headphones according to the invention; and

FIG. 2 shows the connection of the receive module to commercially available headphones.

### DESCRIPTION OF THE PREFERRED EMBODIMENTS

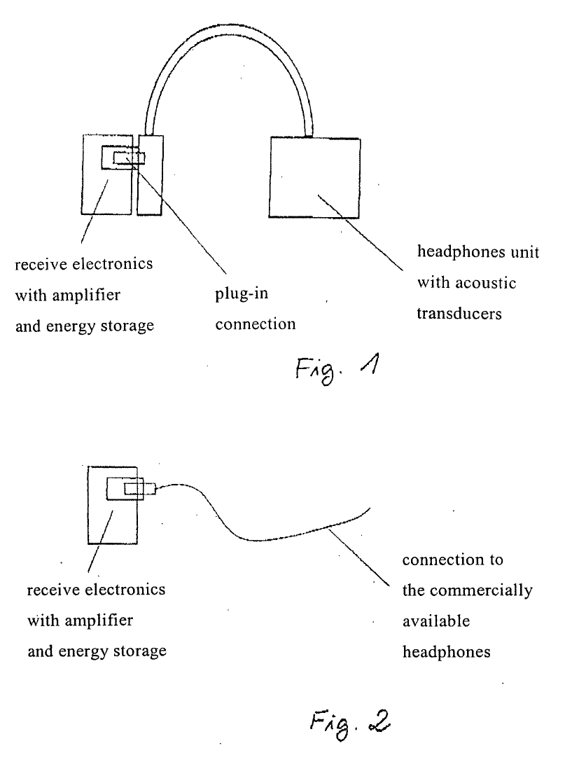

In an elementary representation, FIG. 1 shows wireless headphones 1 having two headphone units 1 and 2, which each contain an acoustic, reproduction transducer. One of the headphone units comprises a plug-in connection by which the headphone unit is connected to a receive module 4 detachable by the plug-in connection. This module 4 comprises a housing 5 in which the receive electronics and an amplifier and also an energy store, e.g., batteries, are housed.

Between the housing and the headphone unit is preferably provided a commercially available plug-in connection, e.g. 3.5 mm stereo jack or the like, e.g. a standardized plug-in connection, but in any case is already common in the headphone field so that it is possible to connect connecting of commercially available wire-bound headphones to it without great expenditure (FIG. 2).

With the wireless headphones according to the invention, it is now possible to connect and operate the wireless headphones on the one hand and also on the other hand to detach the receive module there and then to connect commercially available headphones to it.

Furthermore, the receive module is also equipped with a radio receiver (VHF, FM, AM, DAB). Thus, it is also possible to hear normal radio reception via both types of headphones.

The receiver for the sound signals is preferably an infrared receiver or HF receiver which is directed towards receiving the appropriate radio base station.

The receive module of the wireless headphones according to the invention allows a dual use, namely the use of wireless headphones and, secondly, of wire-bound headphones, which hitherto was not possible.

In the event that the plug-in connection according to the invention is not a commercially available connection, the receive section can be connected to a commercially available appliance by means of an appropriate adapter cable.

Apart from the already described possible applications, the receive section can also be clipped to an amplifier, deaf-aid amplifier, or a mobile telephone receiver or other receivers (NG systems, tinnitus markers, GP or GPS receivers). It is also possible for the clip-on module to be provided with a cable and amplifier.

At this juncture, it is pointed out that a mobile telephone cannot represent the receive part, as it has its own installed loudspeaker and a microphone.

While the foregoing description and drawings represent the present invention, it will be obvious to those skilled in the art that various changes may be made therein without departing from the true spirit and scope of the present invention.

What is claimed is:

1. A receive section for wireless headphones for receiving sound signal data transmitted in wireless manner, the receive section comprising a bush which is configured to house a plug of the headphones.

2. A receive section according to claim 1, wherein the bush is designed to receive a commercially available plug of headphones.

3. A receive section according to claim 1, wherein the receive section contains a battery which is accommodated together with the receive electronics in a housing.

4. A receive section according to claim 1, wherein the housing has a lapel clip on its outer side.

5. A receive section according to claim 1, wherein an amplifier is also accommodated in the housing with the receive electronics and means for adjusting the reproduction and volume are constructed on the outside on the housing.

6. Headphones having a receive section according to claim 1.

7. Headphones having a receive section according to claim 2.

8. Headphones having a receive section according to claim 3.

9. Headphones having a receive section according to claim 4.

10. Headphones having a receive section according to claim 5.
